(19) United States
(12) Patent Application Publication
(10) Pub. No.: US 2007/0050101 A1
(43) Pub. Date: Mar. 1, 2007

(54) Automatic flight protection system for an aircraft

(75) Inventors: Jerome Sacle, Toulouse (FR); Cyril Therrat, Toulouse (FR); Hugues Meunier, Frouzins (FR); Alain Coupier, Toulouse (FR)

Correspondence Address: LOWE HAUPTMAN GILMAN & BERNER, LLP, 1700 DIAGNOSTIC ROAD, SUITE 300, ALEXANDRIA, VA, 22314, US

(73) Assignee: THALES, 92200 NEUILLY SUR SEINE (FR)

(21) Appl. No.: 10/556,789

(22) PCT Filed: Apr. 29, 2004
(86) PCT No.: PCT/EP04/50646

§ 371 Date: Nov. 15, 2005

(30) Foreign Application Priority Data
May 16, 2003 (FR) 03/05903

(51) Int. Cl. G01C 23/00; G06F 17/00

(52) U.S. Cl. 701/11; 701/3

(57) ABSTRACT

This system ensures autonomous protection of an aircraft against deliberate crashes resulting from a malicious act of a person on board or a trajectory error. It comprises a prohibited zone anti-penetration (cons. anti-collision) rig OAPS (54) operating in the manner of a terrain anti-collision rig TAWS (51) but intervening at the level of the flight controls (12) so as to impose an avoidance trajectory on the aircraft (83) when the need therefor is felt. This prohibited zone anti-penetration (cons. anti-collision) rig OAPS (54) uses a database (60) holding information about the prohibited zones and a system for positioning (106, 306) of the aircraft (83). Supplemented with a terrain anti-collision rig TAWS (51) and a rig for protection of the limits of the flight domain FELPS (53), it makes it possible to produce a very complete flight protection system.

The present invention relates to flight safety both as regards the occupants of an aircraft and as regards the inhabitants of the zones overflown.

It is known to take safety measures tending to prevent or at least forestall maneuvers liable to place an aircraft that is still maneuverable in a flight attitude that is dangerous or prejudicial to its structure. It is thus known to limit, from the outset, the rolling and pitching capabilities of an aircraft by setting the deflection travel of the flight controls as a function of the in-flight situation and/or of the loads undergone by the structure.

It is also known to provide an aircraft with aircraft anti-collision rigs termed TCAS (the acronym standing for the expression “Traffic Alert and Collision System”) and with ground anti-collision rigs termed TAWS (the acronym standing for the expression “Terrain Awareness and Warning System”) which warn the crew of a risk of collision with another aircraft or with the ground and which may even, with the approval of the crew of the aircraft, take control of the aircraft so as to place it back in a safe situation. These rigs operate by detecting an intrusion, into a protection envelope surrounding the aircraft, either of another aircraft, or of the ground. In the case of a ground anti-collision rig, the detection of the intrusion of the ground into the aircraft's protection envelope calls upon an onboard positioning system and a terrain database accessible from the aircraft.

These safety measures do not however make it possible to protect the aircraft against a crash caused deliberately by the crew, following an unrecognized piloting error or a malicious act on the part of a hijack crew.

The present invention is aimed at an automatic flight protection system for an aircraft taking account of the untoward actions of the crew.

Its subject is an automatic flight protection system for an aircraft equipped with a positioning system, noteworthy in that it comprises a database, accessible from the aircraft, listing prohibited zones of penetration and a prohibited zone anti-penetration (cons. anti-collision) rig likening the risks of penetration into a prohibited zone to the detection of intrusions of prohibited penetration zones modeled with the help of the elements of the database of prohibited zones, inside at least one flight safety protection envelope constructed around a position deduced from the current position of the aircraft as provided by the positioning system and automatically taking control of the aircraft in case of detection of an intrusion of a prohibited zone of penetration into the flight safety protection envelope.

Advantageously, when it takes control of the aircraft, the prohibited zone anti-penetration (cons. anti-collision) rig makes it follow an avoidance trajectory for avoiding the prohibited penetration zone.

Advantageously, when it has taken control of the aircraft, the prohibited zone anti-penetration (cons. anti-collision) rig renders same to the crew of the aircraft as soon as it no longer detects intrusion of a prohibited zone of penetration into the flight safety protection envelope.

Advantageously, the automatic flight protection system comprises a prohibited zone anti-penetration (cons. anti-collision) rig constructing, in addition to the flight safety protection envelope, a penetration alert protection envelope, that is more extensive than the flight safety protection envelope, and a generator of alerts destined for the crew of the aircraft activated in case of intrusion of a prohibited zone of penetration into this penetration alert protection envelope.

Advantageously, the automatic flight protection system comprises a database storing a representation of the relief or of an envelope of the relief, and a terrain anti-collision rig likening the risks of collision with the ground or obstacles on the ground to the detection of intrusions of the ground or of obstacles on the ground modeled with the help of the representation of the relief or of an envelope of the relief stored in the database, inside at least one ground protection envelope constructed around a position deduced from the current position of the aircraft as provided by the positioning system and alerting the crew of a risk of ground collision in case of detection of an intrusion of the ground or of an obstacle on the ground into the ground protection envelope.

Advantageously, the automatic flight protection system comprises a database storing a representation of the relief or of an envelope of the relief, and a terrain anti-collision rig likening the risks of collision with the ground or obstacles on the ground to the detection of intrusions of the ground or of obstacles on the ground modeled with the help of the representation of the relief or of an envelope of the relief stored in the database, inside at least one ground protection envelope constructed around a position deduced from the current position of the aircraft as provided by the positioning system, alerting the crew of a risk of ground collision in case of detection of an intrusion of the ground or of an obstacle on the ground into the ground protection envelope and offering it an avoidance trajectory.

Advantageously, the automatic flight protection system comprises a terrain anti-collision rig which constructs, in addition to the ground protection envelope, a ground collision prealert protection envelope, that is more extensive than the ground security protection envelope and alerts the crew of the need for a modification of the flight plan in case of intrusion of the ground or of an obstacle on the ground into this ground collision prealert envelope.

Advantageously, the automatic flight protection system comprises a prohibited zone anti-penetration rig and a terrain anti-collision rig having common protection envelopes.

Advantageously, the automatic flight protection system comprises a prohibited zone anti-penetration rig and a terrain anti-collision rig having identical flight safety and ground protection envelopes.

Advantageously, the automatic flight protection system comprises a prohibited zone anti-penetration rig and a terrain anti-collision rig having identical flight safety protection and ground protection envelopes and identical penetration alert and ground collision prealert envelopes.

Advantageously, the automatic flight protection system comprises a prohibited zone anti-penetration rig constructing, in addition to the flight safety protection envelope, a penetration alert protection envelope, a terrain anti-collision rig constructing a ground protection envelope and a ground collision prealert envelope, and a generator of alerts destined for the crew of the aircraft generating several sorts of alarms including:
a prohibited zone penetration risk prealarm in case of intrusion of a prohibited zone of penetration into the penetration alert protection envelope,
a ground collision risk prealarm in case of intrusion of the relief into the ground collision prealert protection envelope, and
a ground collision risk alarm in case of intrusion of the relief into the ground protection envelope.

Advantageously, the automatic flight protection system comprises a rig for alerting the air traffic control through which it advises the air traffic control of any taking of automatic control of the aircraft.

Advantageously, the automatic flight protection system comprises a strengthened surveillance rig actuatable by the crew of the aircraft and/or personnel on the ground and causing an extension of the protection volumes of the prohibited zone anti-penetration rig.

Advantageously, the automatic flight protection system comprises a deactivation rig preventing the function of taking automatic control of the aircraft in case of a major breakdown of the flight rigs of the aircraft or during a final landing maneuver.

Advantageously, the prohibited zone anti-penetration rig acts at the level of the flight controls of the aircraft.

Advantageously, the prohibited zone anti-penetration rig implements protection volumes whose extents are dependent on the speed of the aircraft.

Other advantages and characteristics of the invention will emerge from the description below of an embodiment given by way of example. This description will be offered in conjunction with the drawing in which:

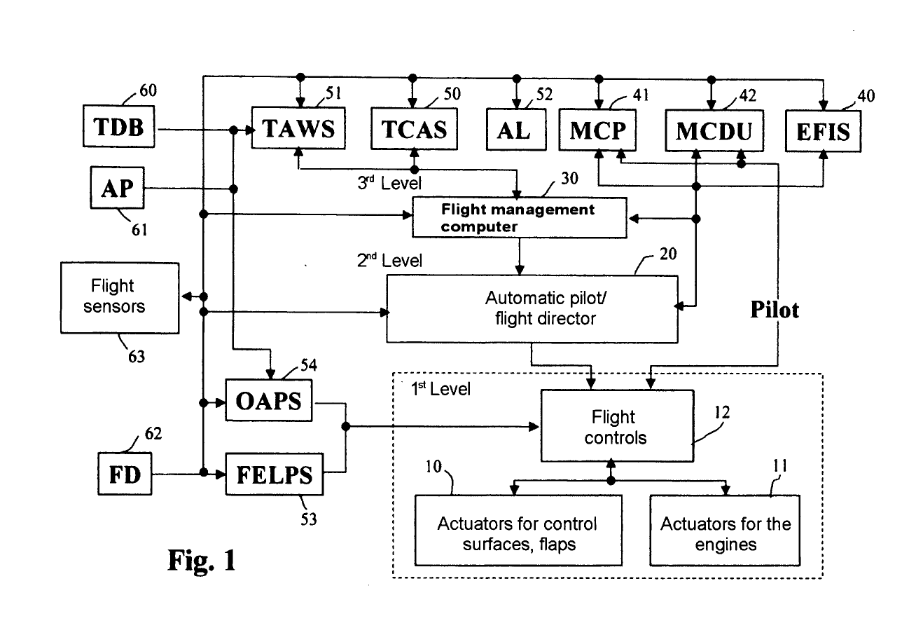

FIG. 1 is a basic diagram of a flight system allowing the piloting of an aerodyne and including an automatic flight protection system according to the invention,

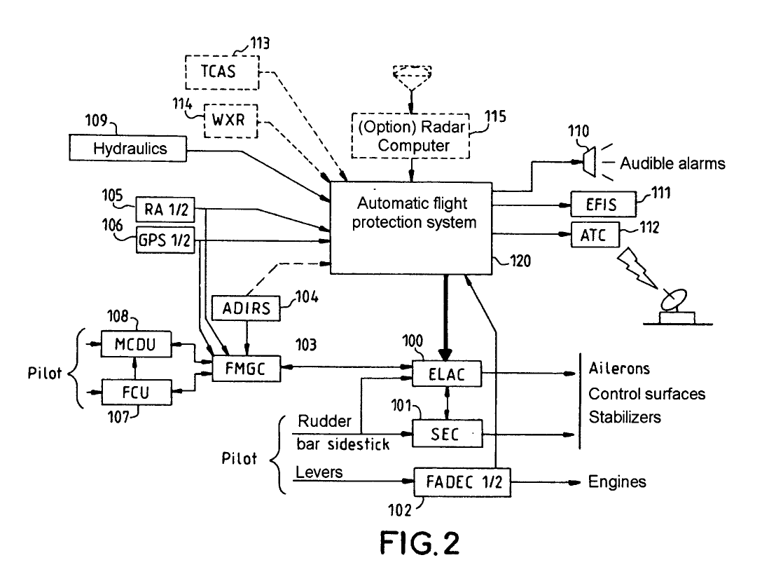

FIGS. 2 to 4 show examples of layout of an automatic flight protection system according to the invention, in the architectures of the flight systems of various transport airplanes, and

FIGS. 5 to 13 give examples of models of avoidance trajectories applicable, according to the situation in progress, by an automatic flight protection system according to the invention.

In a constant desire to enhance flight safety, one has seen the appearance, on aircraft, of systems for automatically limiting the deflection travels of the control surfaces and flaps, and for adjusting the engines intended to preclude, as far as possible, the possibility of the crew placing the aircraft in a flight configuration dangerous to the personnel transported or of subjecting the structure of the aircraft to non-standard loads. Hence, numerous modern aircraft have flight controls provided with functions for mandatory limitation of the pitch and roll maneuvering travels permitted to the crew, taking account of the current flight configuration determined by comparing the flight parameters provided by sensors mounted on the aircraft with the elements of an airplane performance database.

The desire to enhance flight safety has also motivated the development of evermore competitive onboard ground proximity alert rigs.

A first generation of onboard ground proximity alert rigs, today widespread in the aircraft of civil transport airlines, consists of a rig called GPWS (the acronym standing for the expression “Ground Proximity Warning System”) which monitors the height of the aircraft above the ground as measured by a radio altimeter and checks it against the vertical descent speed of the aircraft as measured explicitly or deduced from previous measurements of height above the ground while taking account of various possible situations such as approach, landing, take-off, etc., so as to trigger audible and/or visual alerts in the cockpit in case of detection of a tendency to a dangerous approach to the ground.

A need to improve the first generation GPWS ground proximity alert rigs has rapidly made itself felt. The route followed has been that of increasing the information taken into account by the ground proximity alert rigs relating to the terrain overflown situated ahead and to the sides of the short term forecastable trajectory of the aircraft by profiting from the advent of accurate onboard positioning systems such as satellite-based positioning systems and digitized relief maps that can be stored in airborne terrain databases or ones accessible from the aircraft by radio transmission.

To address this need for improvement, a second generation of airborne ground proximity alert rigs termed TAWS or else GCAS (the acronym standing for the expression “Ground Collision Avoidance System”) has thus appeared, which fulfill, in addition to the customary GPWS functions, an additional function of predictive alert of risk of collision with the relief and/or the ground obstacles termed FLTA (the acronym standing for the expression “predictive Forward-Looking Terrain collision Awareness and alerting”). The role of this FLTA function is to provide the crew with prealerts and alerts whenever the short term forecastable trajectory of the aircraft encounters the relief and/or a ground obstacle so that an avoidance maneuver is engaged. It consists in determining the short term forecastable aircraft trajectory with the aid of information provided by the navigation rigs of the aircraft and possibly an aircraft performance database, so as to delimit, about the position of the aircraft and its forecastable trajectory, at least two protection volumes taking account of the lateral and vertical maneuvering capabilities of the aircraft and of the reaction times of the crew, the larger intended for prealarms giving the crew sufficient time to formulate an avoidance trajectory, the other, the smaller, for the alarms informing the crew of the need for an immediate change of trajectory, and in raising a prealarm or an alarm with each intrusion, into the protection volume concerned, of the relief overflown modeled with the aid of a topographical representation extracted from a terrain database, it being possible for an alarm to give rise to an automatic avoidance maneuver performed under the control of the crew.

For further details on TAWS/GCAS rigs, reference may be made to French Patents 2,689,668, FR 2,747,492, FR 2,773,609 and FR 2,783,912 or to their corresponding American patents: U.S. Pat. No. 5,488,563, U.S. Pat. No. 6,480,120, U.S. Pat. No. 6,088,654 and U.S. Pat. No. 6,317,663.

Various GPWS or TAWG/GCAS airborne rigs process the risks of collision between an aircraft and the relief or an artificial obstacle resulting from unintentional poor navigation stemming from an error of the navigation system of the aircraft or of the terrain database if the former relies on such a base or else of the crew itself. On the other hand, they are of no help in avoiding the intentional crashes of an aircraft onto the relief or an artificial obstacle following a malicious act committed by a person on board the aircraft, whether it be a passenger or a member of the crew, since they will be deliberately deactivated.

To take account of malicious acts committed on board the aircraft, it is necessary that a safety system protecting from the risks of collision with the relief or an artificial obstacle be autonomous and not deactivatable by the crew, in the manner of systems for automatically limiting the deflection travels of control surfaces and flaps, and for adjusting the thrust of the engines.

In order to produce an autonomous and nondeactivatable safety system protecting from the risks of collision with the relief or an artificial obstacle that are due to a deliberate action of a person on board an aircraft, it is proposed to store in a prohibited zones database contours of prohibited zones of penetration, to implement the principle of detection of risks of collision that is used in a TAWS rig with respect to these contours and to take control of the aircraft at the level of the flight controls so as to place it on an avoidance trajectory whenever a manifest risk of penetration into a prohibited penetration zone is detected.

FIG. 1 shows an exemplary flight system including an autonomous and nondeactivatable safety system protecting from the risks of penetration into prohibited zones and hence of intentional collision with natural (relief) or artificial (pylons, antennas, buildings, etc.) obstacles on the ground.

An aircraft is piloted by acting on the orientations of movable surfaces (control surfaces, flaps, etc.) and on the power of its engine or engines. To this end, it comprises, as represented, actuators 10 orienting its control surfaces and flaps, and actuators 11 adjusting the thrust of its engines. These actuators 10 and 11 receive position presets formulated by so-called flight control rigs 12, so as to keep the aircraft in a given attitude, prescribed by the pilot or by an automatic pilot/flight director 20. The flight control rigs 12 constitute together with the actuators 10, 11 a first level of rigs which is distinguished from the other levels by the fact that they are intermediaries indispensable to the pilot for acting on the control surfaces, flaps and engines.

The automatic pilot/flight director 20 eases the task of the pilot by automating the following of presets for heading, altitude, speed, etc. according to two modes: a so-called “automatic pilot” mode where it acts directly on the flight controls 12 and a so-called “flight director” mode where it indicates to the pilot, through the intermediary of EFIS display screens 40 (the initials EFIS standing for the acronym “Electronic Flight Instrument System”), the orders to be given to the flight controls 12 so as to follow a preset. It constitutes a second level of rigs which is distinguished from the first by the fact by the pilot can dispense therewith.

Still with the aim of easing the task of the pilot, the automatic pilot/flight director 20 is often supplemented with an FMS flight management computer 30 (the initials FMS standing for the acronym “Flight Management System”) automating the tasks of formulating and following a flight plan and constituting a third level of rigs by the fact that it intervenes on the piloting of the aircraft solely through the intermediary of the automatic pilot/flight director 20.

The pilot acts on the flight controls through the intermediary of levers or pedals (stick, rudder bar, levers, etc.) and controls the automatic pilot/flight director 20 and the FMS flight computer 30 through the intermediary of two man/machine interfaces one 41 the so-called MCP (the initials standing for the acronym “Module Control Panel”) or FCU (the initials standing for the acronym “Flight Control Unit”) and the other so-called MCDU 42 (the initials standing for the acronym “Multipurpose Control Display Unit”). The MCP interface 41 generally consists of a panel equipped with buttons, indicator lights and displays, and placed like a banner at the base of the windscreen of the flight deck. It promotes ease of use and makes it possible to select directly and to parameterize the modes of operation of the automatic pilot/flight director 20: following of heading, of altitude, of speed, etc. The MCDU interface 42 is a console with keypad and screen generally placed on the central armrest of a flight deck with two piloting stations side by side. It promotes fineness of control and is shared between the automatic pilot/flight director 20, the flight management computer 30 and, more generally, all the onboard rigs requiring parameterization, which rigs it makes it possible to control and to adjust in detail.

To these three levels of rigs are added various rigs contributing to flight safety including:
a TCAS airplane anti-collision rig 50 that can intervene on the flight conduct at the flight management computer 30 level and mentioned for the record since it has no direct relationship with the proposed autonomous safety system protecting from the risks of an intentional crash,
a TAWS ground anti-collision rig 51 which can intervene on the conduct of the flight at the flight management computer 30 level and the ground collision risk detection principle of which is borrowed by the proposed autonomous safety system protecting from the risks of an intentional crash, audible and visual alarm generators 52 controlled by the airplane anti-collision rig 50, ground anti-collision rig 51, by the proposed autonomous safety system protecting from the risks of an intentional crash and more generally by any rig capable of raising alarms destined for the crew of the aircraft,
an FELPS flight domain limit protection rig 53 (the initials standing for the acronym “Flight Envelope Limit Protection System”) which acts at the level of the flight control rigs 12, downstream of the pilot, and whose level of intervention within the flight rigs is borrowed by the proposed autonomous safety system protecting from the risks of an intentional crash and,
an OAPS autonomous safety system 54 (the initials standing for the acronym “Overflight Area Prohibition System”) constituting the core of the automatic flight protection system proposed and protecting from the risks of an intentional crash by intervening, like the flight domain limit protection rig FELPS 53, at the level of the flight control rigs 12.

FIG. 1 also depicts a TDB terrain/obstacles and prohibited zones database 60 and an AP aircraft performance database 61 which are used by the TAWS ground anti-collision rig 51 and by the OAPS autonomous safety system 54, an FD flight domain database 62 used by the flight domain limit protection rig FELPS 53 and a set of flight sensors 63 measuring the flight parameters destined for the various rigs of the flight system.

The TDB database 60 may be airborne or on the ground and accessible from the aircraft by radio transmissions. It holds terrain information utilized by the TAWS ground anti-collision rig 51 and information on limits of prohibited penetration zones utilized by the OAPS autonomous safety system 54.

The terrain information contained in the TDB database 60 is that required for the TAWS ground anti-collision rig 51 for modeling the relief and the artificial obstacles overflown but it may add other information thereto such as the locations of airfields and the safety altitudes, for example, the MORA grid, the MSA, etc. Specifically, the safety altitudes may be used by the OAPS autonomous protection system 54 as limit of a lower prohibited zone not to be overstepped outside the requirements of take-off and landing.

The information regarding limit of prohibited penetration zones contained in the TDB database 60 allows the autonomous protection system to model a surface surrounding and/or overlapping a prohibited penetration zone that the aircraft has no right to cross, for example by a ground trace and a minimum height threshold. The prohibited penetrated zones may relate to: town centers, nuclear and industrial plants, military bases, monuments and customary places where people assemble, such a list not being exhaustive. Furthermore, it is possible for them to be only temporarily prohibited.

The AP aircraft performance database 61 and the FD flight domain database 62 are airborne databases holding information on the characteristics of the aircraft utilized either by the TAWS ground anti-collision rig 51 and by the OAPS autonomous safety system 54, or by the flight domain limit protection rig FELPS 53.

The set of flight sensors 63 encompasses: pressure sensors, angle of incidence vane, and inertial reference system, these generally being referenced ADIRS (the initials standing for the acronym “Air Data/Inertial Reference System”) or ADIRU (the initials standing for the acronym “Air Data/Inertial Reference Unit”), radio altimeter RA, GPS/GNSS satellite-based positioning receiver, WXR weather radar, etc.

The OAPS autonomous protection system 54 borrows the principle of detection of risk of ground collision and the procedures for formulation of avoidance trajectory of a TAWS ground anti-collision rig with which it may possess numerous common parts, but applies these procedures vis-à-vis a modeling of the limits of the prohibited zones of penetration. The principle of detection of risk of ground collision implemented in a TAWS ground anti-collision rig consists, as recalled previously, in constructing, around the position of the aircraft and its short term forecastable trajectory, one or more protection volumes and in considering any intrusion, into these protection volumes, of the relief overflown, modeled on the basis of cartographic information stored, such as a risk of ground collision that is more or less severe as a function of the extent of the protection volume considered. The processes for formulating avoidance trajectories consist in searching for an upward or sideways evasive maneuver if an upward evasive maneuver is not within the reach of the maneuvering capabilities of the aircraft. These processes of detection of risk of ground collision and of formulation of avoidance trajectory will not be detailed since they are known to the person skilled in the art. For details thereof, reference may usefully be made to the patents mentioned above.

In the exemplary embodiment illustrated in FIG. 1, the TAWS ground anti-collision rig 51 models the relief overflown on the basis of cartographic information gleaned from a TBD database 60. It goes without saying that it can also use a modeling of the relief overflown arising from some other rig of the aircraft, for example a weather radar if the latter has a ground mapping function. In the latter case, the TBD database 60 now only has to store information on the limits of prohibited penetration zones.

In a preferred manner, the TAWS ground anti-collision rig 51 and the OAPS autonomous protection system 54 implement the same protection volumes: an alarm protection volume and a prealarm protection volume of larger extent.

Detections of intrusion into the prealarm protection volume either of the relief overflown by the TAWS ground anti-collision rig 51, or of a limit of prohibited zone of penetration by the OAPS autonomous protection system 54, give rise to prealarms, either of a forthcoming terrain collision if the transmitter is of the TAWS ground anti-collision rig 51, or of a forthcoming penetration into a prohibited zone if the transmitter is the OAPS autonomous protection system 54, which are intended to draw the attention of the crew to the need to modify the short term trajectory of the aircraft.

Detections of intrusion into the alarm protection volume either of the relief overflown by the TAWS ground anti-collision rig 51, or of a limit of prohibited zone of penetration by the autonomous protection system OAPS 54, give rise to alarms, either of a possibility of terrain collision in the very short term if the transmitter is of the TAWS ground anti-collision rig 51, or of a penetration in the very short term into a prohibited zone, alarms both requiring an immediate change of short term trajectory of the aircraft. In both cases, these alarms are accompanied by the formulation of avoidance trajectories but these avoidance trajectories translate, in the case of the TAWS ground anti-collision rig, into presets for the automatic pilot/flight director 12 coming from the FMS flight management computer 30 and of which the crew may be unaware and, in the case of the OAPS autonomous protection system 54, into presets of the flight control rigs 12 to which the crew is subject.

Ultimately, the functions of detection of risk of penetration into a prohibited zone and of formulation of avoidance trajectory of the OAPS autonomous protection system 54 may be afforded at the cost of slight modifications, often software modifications only, by a TAWS ground anti-collision rig 51. As far as the implementation of an avoidance trajectory at the level of the ground control rigs is concerned, it may be effected, likewise at a small price, by using the accessway of the FELPS flight domain limit protection rig 53.

A prealarm of a forthcoming penetration into a prohibited zone originating from the OAPS autonomous protection system 54 is of no interest other than to a crew of good faith. It may therefore be managed in the same manner as a prealarm of a forthcoming terrain collision emanating from the TAWS ground anticollision rig 51 and consist, at base, of advice of the “pull up” type. Nevertheless, in cases of ineffectiveness of such a maneuver the “pull up” advice will not be given but replaced with a simple warning of risk of overstepping of a prohibited limit, so as not to induce further error on a crew already the victim of a navigation error and seeking to resume control of the trajectory of the aircraft.

At the level of a prealarm, the OAPS autonomous protection system 54 does not impede the resumption of control of the trajectory by the pilot. It may even, since the functions thereof are then afforded by the same circuits as the TAWS ground anticollision rig 51, advise the pilot, through the intermediary of the flight director 12, of the control to be applied to the stick in terms of pitch and roll so as to deviate away from the prohibited zone.

Coupled with a TAWS ground anticollision rig 51, the OAPS autonomous protection system 54 proposed makes it possible to afford flight protection in three phases:
a phase of detection of natural and artificial obstacles (current function of a TAWS),
a phase of prealarm prompting the crew to change the trajectory of the aircraft (current function of a TAWS),
a phase of alarm with, either a possibility of automatically taking control of the aircraft, under the authority of the crew if the alarm is an alarm of ground collision without penetration of a prohibited zone, or mandatory taking of control of the aircraft outside of the authority of the crew if the alarm is an alarm of penetration of prohibited zone.

With respect to the FELPS flight domain limit protection rigs that are encountered in particular, in aircraft with electric flight controls, the OAPS autonomous protection system 54 proposed adds, to the protection of the flight domain limits, the taking into account of a flight safety envelope, an anticrash envelope as it were. The entire flight is thereby protected. Compliance with the limits of the flight domain and that of the flight safety envelope may be afforded by separate rigs acting at the level of the flight controls or by a single rig which is dubbed the FFPS (the initials standing for the acronym “Full Flight Protection System”).

Automatic resumption of control, mandatory or otherwise, is done by vertical and/or lateral guidance of the aircraft that can use predefined avoidance models corresponding to the conflict situation encountered. Once a prohibited zone has been avoided, the system returns control to the pilot in a safety configuration, for example, wings horizontal.

The mandatory taking of control of the aircraft by the autonomous protection system occurs only as a last resort. The crew has command of the aircraft so as long as they do not direct the latter into a prohibited zone possibly leading to the loss of the aircraft and/or to damage to third parties. During a phase of automatic resumption of control, be it mandatory or otherwise, the action of the pilot on the stick can be taken into account if said action permits clearer avoidance (increased margins) of the zone considered.

Should the crew not perform any corrective action following a prealarm of risk of penetration into a prohibited zone, the OAPS autonomous protection system 54 waits for the triggering of an alarm of penetration of prohibited zone to take control of the aircraft in terms of pitch and roll at the level of the flight controls and to reposition it on a safe trajectory avoiding the prohibited zone and the relief. The aircraft control order is formulated by the OAPS autonomous protection system 54 and not by the flight control rigs 12. Automatic and mandatory resumption of control of the aircraft is effected at the limit location where a relatively tight manual trajectory would still allow the crew to clear the conflict zone while complying with the limitations of the envelope of the flight domain and a trajectory margin so that the aircraft does not approach obstacles dangerously upon manual or automatic resumption of the flight.

Should the crew begin an avoidance maneuver judged to be too slow, the system resumes control in automatic mode.

Should the crew begin a suitable avoidance maneuver, the autoguidance is not activated.

During the automatic and mandatory resumption of control of the aircraft, the orders applied by the pilot to the stick may be added to the automatic orders when they go in the right direction and comply with the limits of the envelope of the flight domain. A tighter avoidance maneuver is thus obtained.

Automatic and mandatory resumption of control of the aircraft may implement, as a function of the conflict situation encountered, several predefined models of avoidance trajectory. During the avoidance maneuver imposed on the crew, the evolution of the position of the aircraft vis-à-vis the relief is monitored by the TAWS rig 51 under the control of the OAPS autonomous protection system 54 and possibly modified so as to ward off any detected risk of ground collision.

The OAPS autonomous protection system 54 may furthermore alert the air traffic control through the intermediary of the RF transmission rigs of the aircraft, for example, by means of a priority transponder code so that it takes account of the urgent and mandatory change of trajectory. Of course, this code is not modifiable by the crew until landing or until the end of the avoidance procedure.

Throughout the phase of taking of control of the aircraft by the OAPS autonomous protection system 54, the crew is warned by a message displayed on an EFIS display screen 40 such as, for example, the PFD screen (the initials standing for the acronym “Primary Flight Display”). Furthermore, the flight director 20 displays the presets applied to help the pilot to understand the flight situation and ease any manual intervention on his part.

At the end of the mandatory maneuver for avoiding a prohibited zone, the OAPS autonomous protection system 54 places the aircraft back on a safe trajectory, returns control to the crew and deletes any message of taking of control of the aircraft.

The OAPS autonomous protection system 54 can comprise a particular mode of operation termed active standby which is triggered by the crew, for example by actuating a “panic” button, when they discern behavior that is threatening to onboard safety, on the part of one or more persons aboard, and which corresponds to an enlarged alarm protection volume making it possible to anticipate with greater margin the actions aimed at plunging the aircraft against an obstacle or the terrain. This mode of operation that cannot be deactivated until the end of the flight may admit particular features in the functional design such as, for example, the possibility of guiding the aircraft in a mandatory manner to an appropriate airfield and of managing the landing thereat.

The OAPS autonomous protection system 54 comprises a deactivation function for emergency situations: engine breakdown, hydraulic breakdown, etc., where an aircraft must be able to be maneuvered freely irrespective of the environment in terms of obstacles so that the crew has the possibility of performing a landing in countryside or of circling at very low altitude so as to rejoin a runway or a route, and for the landing which is a critical phase of the flight that must not be interrupted, the aircraft approaching very close to the ground.

This deactivation function determines the emergency situations by analyzing the critical parameters of the aircraft (FADEC, hydraulic parameters, etc.) but does not consider a deliberate shutdown of an engine or of several engines as an emergency situation. If a malicious crew cuts all the engines manually, the OAPS autonomous protection system 54 does not deactivate itself compelling the aircraft to avoid, in its glide, the prohibited zones and to steer, insofar as possible, towards the closest runway or failing this until touchdown toward a zone devoid of artificial obstacles and having the flattest possible relief (“controlled crash”). The action of throwing the aircraft onto a point target, engine shutdown, is thus very likely to fail, the crew not knowing the crash zone chosen by the system.

The deactivation function determines a situation of landing through the location of the aircraft in the runway zone of a landing field. It puts an end to a mandatory avoidance maneuver engaged by the OAPS autonomous protection system 54 in the final pass before crossing the runway threshold and displays a message on the EFIS screens warning the crew that it has responsibility for landing. The OAPS autonomous protection system 54 nevertheless remains on standby to correct any maneuver at very low altitude outside of the volume of the runway axis.

On the approach to an airport, the OAPS autonomous protection system 54 can reduce, as a function of the decreasing speed of the aircraft, the protection volume around the aircraft on the basis of which it detects prohibited zone limit intrusions on which it bases its alarm so as to decrease the margin of precaution taken with respect to a prohibited zone since an aircraft is more maneuverable at reduced speed. With this aim, it can use the approach recognition models described for TAWS rigs in French Patent FR 2,783,912 and American patent U.S. Pat. No. 6,317,663.

To enhance the safety of the OAPS autonomous protection system 54, which is a critical system in the same way as the flight control rigs 12, the automatic pilot/flight director 20 and the FELPS flight domain limit protection rig 53, the latter receives consolidated information originating from multiple independent sources via redundant pathways. Thus, the altitude information that it receives originates from a double radio altitude/database source by application of a process of altitude consolidation such as that employed in the TAW rigs and possibly of a radio altitude/database/“ground map” mode trio of information of the weather radar. Likewise the position information that it receives may originate from the consolidation of two items of position information provided by two independent GPS/GNSS satellite-based positioning receivers on board the aircraft.

Still with the aim of enhancing its safety of operation, the OAPS autonomous protection system 54 is equipped with a BITE function for monitoring proper operation (the initials standing for the acronym “Built In Test Equipment”) performing tests and fault diagnoses and deactivating a mandatory taking of control of the aircraft in case of detection of a fault compromising either the formulation of the avoidance trajectory, or the integrity of the orders destined for the flight control rigs 12 but nevertheless allowing the Detection and Alert functions to continue to operate as long as they are not affected by a fault.

The OAPS autonomous protection system 54 may be embodied according to a modular architecture based on several redundant modules of LRU type (the initials standing for the acronym “Line Replaceable Unit”) so as to retain the availability of the function should an LRU module be damaged.

More generally, the OAPS autonomous protection system 54 has an architecture with positive safety (“fail safe”) that is hardened so as to preclude any impairment of its operation by an outside intervention (location inaccessible from the flight deck) and any deactivation by action on the supply circuits of the various subsystems (no switches or breakers manually operable from the flight deck or any part whatsoever of the aircraft accessible during the flight on the electrical supply circuits of the OAPS autonomous protection system 54 and the Radio Altimeters RA, GPS, FADEC, Hydraulic System, computers of the electric flight controls).

The OAPS autonomous protection system 54 does not demand very accurate information on the position of the aircraft. An accuracy of the order of some twenty meters is acceptable so that the positioning information may originate from a satellite-based positioning receiver possibly twinned for safety without calling upon an inertial reference rig IRS (standing for the acronym “Inertial Reference System”).

The implementation of the OAPS autonomous protection system 54 in the architecture of the flight rigs of an aircraft with electric flight controls may be done through the following adaptations:
modification of the TAWS ground anticollision rig so that it also affords the functions afforded by the OAPS autonomous protection system,
addition of an interface to the flight control computers so that they accept priority maneuver orders originating from the modified ground anticollision rig,
adaptation of the GPS, FADEC, HYDRAULIC and Radio Altimeter systems within the framework of the interface so that they acquire a “fail safe” character and are not deactivatable by breaker during the flight,
adaptation of the transponder to receive a system alert code, having priority over the other codes, that cannot be modified by the crew,
adaptation of the EFIS screens to display the planned automatic resumption trajectory (navigation screen ND) in addition to the terrain and obstacles, and the system alert messages (artificial horizon PFD),
adaptation of the audio generation unit to generate vocal prealarm and alarm messages sent by the modified TAWS rig.

FIGS. 2 to 4 illustrate examples of the layout of an FFPS automatic flight protection system (the initials corresponding to the acronym standing for: “Full Flight Protection System”) bringing together the functions of an autonomous protection system preventing any penetration into a prohibited zone, of an FELPS flight domain limit protection rig and of a TAWS ground anticollision rig, in the architecture of a flight system of various transport airplanes.

FIG. 2 gives an exemplary layout of an FFPS flight automatic protection system in the architecture of the flight system of an Airbus A320 type airplane. This type of airplane comprises flight control rigs formed from two task sharing computers for maneuvering the movable surfaces of the airplane: ailerons, control surfaces, stabilizers, etc., one 100 termed ELAC (the initials standing for the acronym “Elevator and Aileron Computer”) and the other 101 termed SEC (the initials corresponding to the acronym standing for the expression “Spoiler and Elevator Computer”) and of an FADEC computer 102 doubled up for safety for controlling the engines. The ELAC computer 100 and SEC computer 101 respond to the requests of the pilot by way of a so-called “sidestick” and of a rudder bar as well as to the directives of a computer 103 termed FMGC (the initials corresponding to the acronym standing for the expression “Flight Management and Guidance Computer”) affording the functions of an FMS flight management computer, of an automatic pilot and of a flight director. The FMGC computer 103 receives information on the flight parameters from a set 104 of sensors termed ADIRS (the initials corresponding to the acronym standing for the expression “Air Data/Inertial Reference System”) of a radio altimeter RA 105 doubled up for safety and of a GPS satellite-based positioning receiver 106 also doubled up for safety, and responds to the directives of the pilot reaching it via the man/machine interfaces FCU 107 and MCDU 108. In addition to these elements, the flight system of an airbus A320 comprises a hydraulic system 109 for actuating the movable elements of the airplane, a generator of audible alarms 110, EFIS display screens 111, an ATC system 112 for radio communication with the ground, and possibly, a TCAS aircraft anticollision rig 113 and a WXR weather radar 114 able to have a mapping function 115, whose links with the FMGC computer 103 have not been represented for the sake of simplifying the figure.

The FFPS automatic flight protection system 120 is integrated at the center of this flight system architecture. It receives information on the flight parameters originating from the radio altimeter RA 105, from the satellite-based positioning receiver 106, from the hydraulic system 109 and possibly from the set of ADIRS sensors 104, from the TCAS anticollision rig 113 and from the weather radar 114 via dedicated links. It delivers flight directives that may override the requests of the pilot to the ELAC computer 100 and SEC computer 101 for the flight controls, information destined for the crew by way of the generator of audible alarms 110 and EFIS screens 111, and information destined for the air traffic control by way of the ATC transmission rig 112.

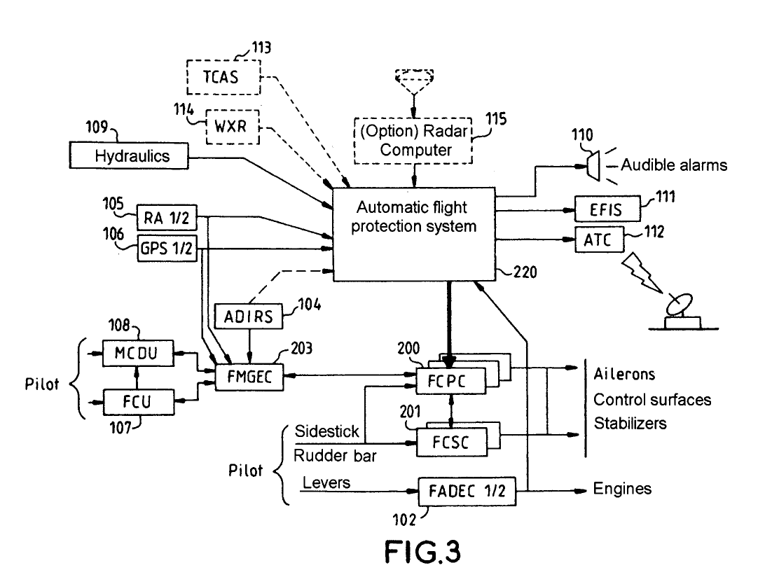

FIG. 3 gives another example of a layout, in the architecture of the flight system of an Airbus A330/340 type airplane, of an FFPS automatic flight protection system 220 bringing together the functions of an autonomous protection system preventing any penetration into a prohibited zone, of an FELPS flight domain limit protection rig and of a TAWS ground anticollision rig. The flight system of an Airbus A330/340 type airplane is distinguished from that shown in FIG. 2 by the embodiment of the flight control rigs which call upon two entirely redundant and modular computers for maneuvering the movable surfaces of the aircraft, one 200 termed FCPC (the initials corresponding to the acronym standing for the expression “Flight Control Primary Computer”) and the other 201 termed FCSC (the initials corresponding to the acronym standing for the expression “Flight Control Secondary Computer”) and by a different flight management computer 203 termed FMGEC (the initials corresponding to the acronym standing for the expression “Flight Management and Guidance Envelope Computer”). The other rigs unchanged with respect to FIG. 2 retain the same indexations.

The FFPS flight automatic protection system 220 is integrated at the center of this flight system architecture in a manner very much like the previous case. It receives information on the flight parameters originating from the radio altimeter RA 105, from the satellite-based positioning receiver 106, from the hydraulic system 109 and possibly from the set of ADIRS sensors 104, from the TCAS anticollision rig 113 and from the weather radar 114, delivers information destined for the crew by way of the generator of audible alarms 110 and EFIS screens 111, and information destined for the air traffic control by way of the ATC transmission rig 112 and applies flight directives that can override the requests of the pilot to the FCPC computer 200 and FCSC computer 201 of the flight controls.

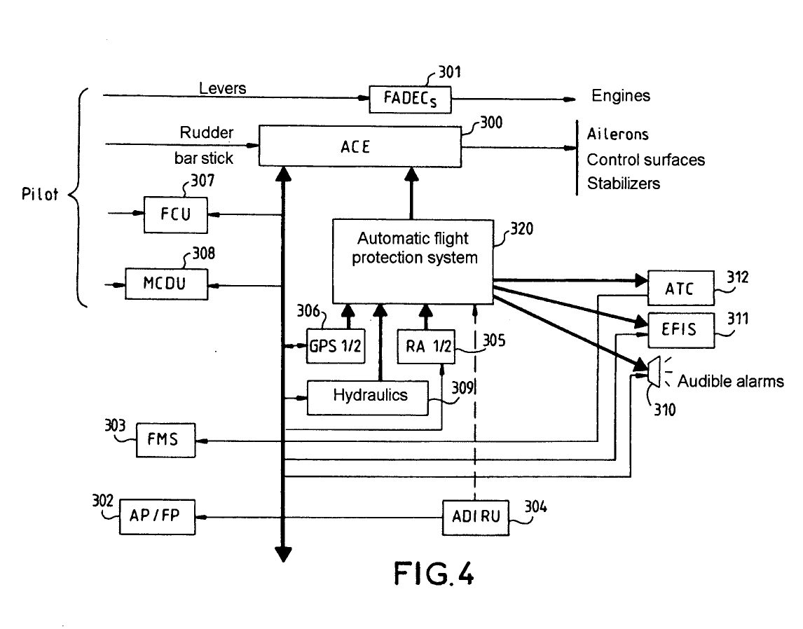

FIG. 4 gives yet another example of a layout, in the architecture of the flight system of a Boeing 777 type airplane, of an FFPS automatic flight protection system 320 bringing together the functions of an autonomous protection system preventing any penetration into a prohibited zone, of an FELPS flight domain limit protection rig and of a TAWS ground anticollision rig. This type of airplane comprises flight control rigs formed of redundant computers 300 for controlling the actuators of the movable surfaces of the aircraft: ailerons, control surfaces, stabilizers, etc., termed ACE (the initials corresponding to the acronym standing for the expression “Actuator Control Electronics”) and of an FADEC computer 301 doubled up for safety for the control of the engines. The ACE computer 300 responds to the requests of the pilot by way of a so-called “control column” and of a rudder bar as well as to the directives of an automatic pilot/flight director 302 termed AP/FD (the initials corresponding to the acronym standing for the expression “Auto Pilot/Flight. Director”) and of an FMS flight management computer 303. The automatic pilot/flight director AP/FP 302 and the FMS flight management computer 303 receive information on the flight parameters from a set 304 of so-called ADIRU sensors (the initials corresponding to the acronym standing for the expression “Air Data/Inertial Reference Unit”), of a radio altimeter RA 305 doubled up for safety and of a GPS satellite-based positioning receiver 306 also doubled up for safety and responds to the directives of the pilot reaching it via the man/machine interfaces FCU 307 and MCDU 308. In addition to these elements, the flight system of a Boeing 777 comprises a hydraulic system 309 for actuating the movable elements of the aircraft, a generator of audible alarms 310, EFIS display screens 311, an ATC system 312 for radio communication with the ground, and, possibly, a TCAS aircraft anticollision rig and a WXR weather radar that can have a mapping function 115, all not represented.

As previously, the FFPS automatic flight protection system 320 is integrated at the center of the flight system architecture. It receives information on the flight parameters originating from the radio altimeter RA 305, from the GPS satellite-based positioning receiver 306, from the hydraulic system 309 and possibly from the set of ADIRU use sensors 304 via dedicated links, delivers information destined for the crew by way of the generator of audible alarms 310 and EFIS screens 311, and information destined for the air traffic control by way of the ATC transmission rig 312 and applies flight directives that can override the requests of the pilot to the ACE computers 300 for the flight controls.

FIGS. 5 to 13 illustrate examples of avoidance trajectory models, applicable, according to the situated encountered, by the OAPS autonomous protection system 54 or by an FFPS flight protection automatic system 120, 220, 320. For convenience, the avoidance trajectory models represented are models of purely lateral or purely vertical avoidance trajectory, but it goes without saying that the combination of a lateral trajectory model with a vertical trajectory model is possible.

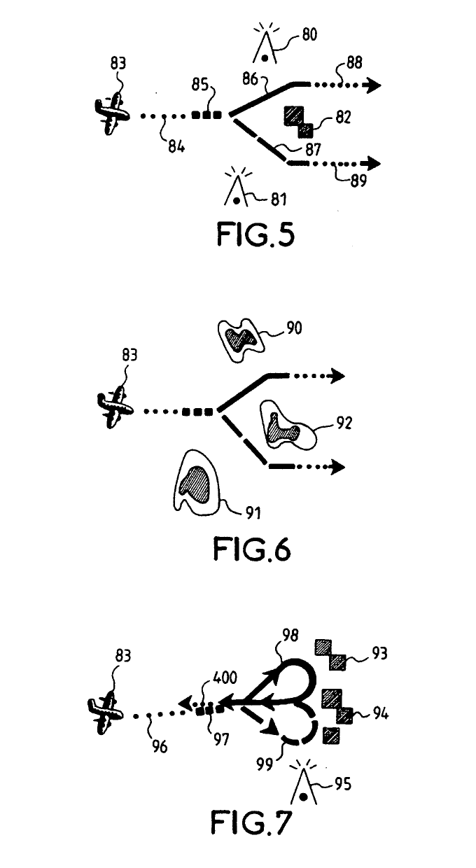

FIGS. 5 and 6 illustrate cases of lateral avoidance to the right or to the left, at constant altitude, of prohibited zones of penetration of limited dimensions but which cannot be overstepped from above (no prealarm or alarm of “pull up” type).

In FIG. 5, the prohibited zones of penetration of limited dimensions are obstacles such as antennas 80, 81 or a building 82 that are relatively far apart. The aircraft 83 arrives, opposite the building 82, on a trajectory 84 controlled by the pilot and drawn dotted. At a certain distance from the building 82 regarded as a prohibited zone of penetration, the automatic flight protection system FFPS or the autonomous protection system OAPS of the aircraft 83 detects a risk of penetration into a prohibited zone and raises a prealarm intended for the pilot while the aircraft 83, still controlled by the pilot, continues its progress towards the building 82 (part of the trajectory 85 labeled by dashes). The pilot having ignored the prealarm, the FFPS automatic flight protection system or the OAPS autonomous protection system goes to alarm mode and takes control of the aircraft 83 so as to divert it around the building without risking collision with the antennas 80, 81, either to the left along the avoidance trajectory 86 drawn with a continuous line, or to the right along the avoidance trajectory 87 drawn with broken lines. The building 82 avoided and the aircraft 83 placed in safe flight mode, the FFPS automatic flight protection system or the OAPS autonomous protection system of the aircraft 83 hands control back to the pilot who continues his course along one or other of the trajectories 88 or 89 drawn dotted.

FIG. 6 illustrates a situation similar to that in FIG. 5 in which the prohibited penetration zones consist of reliefs 90, 91, 92 of limited dimensions. The aircraft 83, its pilot and its FFPS automatic flight protection system or its OAPS autonomous protection system have the same behavior as in FIG. 5.

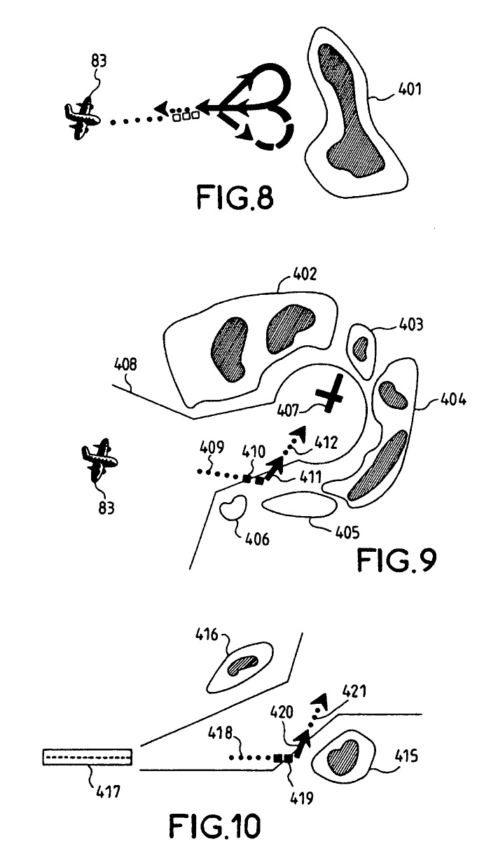

FIGS. 7 and 8 illustrate cases of lateral avoidance, by about-turn, of a prohibited penetration zone, of extended dimension, that cannot be overstepped from above (no prealarm or alarm of “pull up” type). In FIG. 7, the prohibited penetration zone is an extended set, formed of buildings 93, 94 and of an antenna 95. The aircraft 83 arrives, opposite the set of buildings 93, 94, on a trajectory 96 controlled by the pilot and drawn dotted. At a certain distance from the set of buildings 93, 94 and from the antenna 95 regarded as a prohibited penetration zone, the FFPS automatic flight protection system or the OAPS autonomous protection system of the aircraft 83 detects a risk of penetration into a prohibited zone and raises a prealarm destined for the pilot while the aircraft 83, still controlled by the pilot, continues its progress towards the set of buildings 93, 94 (part of the trajectory 97 labeled by dashes). The pilot having ignored the prealarm, the automatic flight protection system FFPS or the autonomous protection system OAPS goes to alarm mode and takes control of the aircraft 83 so as to make it about turn, either to the left along the avoidance trajectory 98 drawn with a continuous line, or to the right along the avoidance trajectory 99 drawn with broken lines. The set of buildings 93, 94 and the antenna 95 that are avoided, and the aircraft 83 placed in safe flight mode, the automatic flight protection system FFPS or the autonomous protection system OAPS hands control back to the pilot who continues his course along a trajectory 400 opposite to his initial trajectory and drawn dotted.

FIG. 8 illustrates a situation similar to that of FIG. 7 in which the extended prohibited penetration zone consists of a relief 401. The aircraft 83, its pilot and its FFPS automatic flight protection system or its OAPS autonomous protection system have the same behavior as in FIG. 7.

FIG. 9 illustrates the case of a lateral avoidance of prohibited penetration zones consisting of reliefs 402 to 406 running alongside an airport 407 and necessitating compliance with an approach corridor 408. The contour of the approach corridor 408 is likened by the FFPS automatic protection system or the OAPS autonomous protection system of the aircraft 83 to the union of the limits of the prohibited zones. The aircraft 83 arrives, in the approach phase, heading for the relief 405 so as to take the runway axis, along a trajectory 409 controlled by the pilot and drawn dotted. The pilot delays his turn for too long so that the aircraft 83 continuing its trajectory (part of the trajectory 410 labeled by dashes) approaches too close to the reliefs 405, 406 and that its FFPS automatic flight protection system or its OAPS autonomous protection system detects a risk of penetration into a prohibited zone and raises a prealarm destined for the pilot. The pilot having ignored the prealarm, the FFPS automatic flight protection system or the OAPS autonomous protection system goes to alarm mode and takes control of the aircraft 83 so as to reposition it towards the inside of the approach corridor, in divergence with its limit 408, along a trajectory 411 drawn with a continuous line. Once the detection of a risk of penetration into the prohibited zone has disappeared and once the aircraft 83 has gone to safe flight mode, the FFPS automatic flight protection system or the OAPS autonomous protection system hands control back to the pilot who continues his approach along a trajectory 412 drawn dotted.

FIG. 10 illustrates another case of a lateral avoidance of prohibited penetrated zones consisting of reliefs 415, 416 running alongside an airport 417 and necessitating compliance with a corridor, on takeoff or in case of an interrupted approach. The sides of the corridor are likened by the FFPS automatic protection system or the OAPS autonomous protection system of the aircraft 83 to those of the prohibited zones 415, 416. The aircraft 83, in the take off phase, follows, under the control of the pilot, a trajectory 418 drawn dotted, following the axis of the runway of the airport heading for the relief constituting the prohibited zone 415. The pilot delays his turn too long so that the aircraft 83 continuing its trajectory (the part of the trajectory 419 labeled by dashes) approaches the relief 415 too closely and that its FFPS automatic flight protection system or its OAPS autonomous protection system detects a risk of penetration into the prohibited zone and raises a prealarm destined for the pilot. The pilot having ignored the prealarm, the FFPS automatic flight protection system or the OAPS autonomous protection system goes to alarm mode and takes control of the aircraft 83 so as to reposition it towards the inside of the take off corridor, in divergence with respect to the limit of the corridor, along a trajectory 420 plotted in a continuous line. Once the detection of a risk of penetration into the prohibited zone has disappeared and once the aircraft 83 has been placed in safe flight mode, the FFPS automatic flight protection system or the OAPS autonomous protection system hands control back to the pilot who continues his take off along a trajectory 421 drawn dotted.

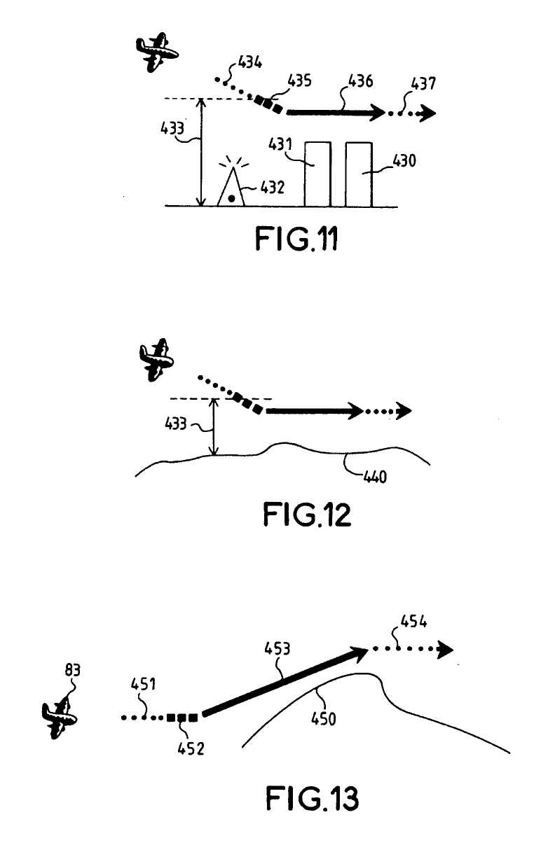

FIGS. 11 and 12 illustrate the cases of vertical avoidance of a prohibited penetration zone with a vertical protection limit.

In FIG. 11, the prohibited penetration zone with vertical protection limit consists of a set of buildings 430, 431 and of an antenna 432 that are not to be overflown below a minimum altitude 433. The aircraft 83 arrives, while descending, on a trajectory 434 controlled by the pilot and drawn dotted. The pilot delays his leveling out too long so that the FFPS automatic flight protection system or the OAPS autonomous protection system of the aircraft 83 detects a risk of overstepping of the minimum altitude permitted and raises a prealarm destined for the pilot while the aircraft 83, still controlled by the pilot, continues its descent (part of the trajectory 435 labeled by dashes). The pilot having ignored the prealarm, the automatic flight protection system FFPS or the autonomous protection system OAPS goes to alarm mode and takes control of the aircraft 83 so as to level it out along the trajectory 436 drawn in a continuous line. The minimum altitude complied with and the aircraft 83 having been placed in safe flight mode, the FFPS automatic flight protection system or the OAPS autonomous protection system of the aircraft 83 hands control back to the pilot who continues his course along the trajectory 437 drawn dotted.

FIG. 12 illustrates a situation similar to that of FIG. 11 in which the prohibited zone of penetration below a minimum altitude consists of the relief 440. The aircraft 83, its pilot and its FFPS automatic flight protection system or its OAPS autonomous protection system have the same behavior as in FIG. 11.

FIG. 13 illustrates a case of vertical avoidance of a prohibited penetration zone with vertical protection limit in the case of an aircraft 83 reaching the prohibited zone, here a relief 450, while it is flying level at an altitude below the limit of vertical protection of the prohibited zone but nevertheless its performance allows its avoidance of the prohibited zone from above. The aircraft 83 arrives, flying level, heading for the prohibited zone 450, on a trajectory 451 controlled by the pilot and drawn dotted. The pilot keeps level for too long so that the FFPS automatic flight protection system or the OAPS autonomous protection system of the aircraft 83 detects a risk of penetration of the space of the prohibited zone and raises a prealarm destined for the pilot while the aircraft 83, still under control of the pilot, continues flying level (part of the trajectory 452 labeled by dashes). The pilot having ignored the prealarm, the FFPS automatic flight protection system or the OAPS autonomous protection system goes to alarm mode and takes control of the aircraft 83 so as to make it go to an altitude above the minimum altitude imposed on the prohibited zone, along an ascending trajectory 453 drawn with a continuous line. The minimum altitude complied with and the aircraft 83 having been placed in safe flight mode, the FFPS automatic flight protection system or the OAPS autonomous protection system of the aircraft 83 hands control back to the pilot who continues his course along the trajectory 454 drawn dotted.

The automatic flight protection system just described generalizes the principle of the protection of the flight domain towards overall flight protection including protection with respect to reliefs and obstacles. It does not intervene in the maneuvers of the crew under normal, emergency or rescue conditions. It alerts the crew of the approach to an obstacle or of a risk of penetration into a prohibited zone that might seriously endanger the continuation of the flight and the populations overflown. In case of trajectory error, it allows the crew to resume the appropriate trajectory rapidly. In case of deliberate malicious act, it limits the possible loss of the aircraft and the damage caused to third parties that would result therefrom. It takes mandatory control of the aircraft only as a last resort when the probability of the crew reacting favorably to save the aircraft becomes small. By reducing the crash risks related to trajectory errors or to malicious acts, it helps both with the security and safety of air transport.

The architecture proposed for this automatic flight protection system is well suited to aircraft with electric flight controls, in which aircraft the sticks, levers, rudder bars available to the pilot are easily neutralizable. Moreover, the FMS flight management computer can interface therewith for the purpose of anticipating the predictions of conflict of the flight plan with the terrain at both the lateral and vertical level.

1. An automatic flight protection system for an aircraft equipped with a positioning system comprising:
a database, accessible from the aircraft, listing prohibiting zones of penetration and a prohibited zone anti-penetration rig likening the risks of penetration into a prohibited zone to the detection of intrusions of prohibited penetration zones modeled with the help of the elements of the database, inside at least one flight safety protection envelope constructed around a position deduced from the current position of the aircraft as provided by the positioning system and automatically taking control of the aircraft in case of detection of an intrusion of a prohibited zone of penetration into the flight safety protection envelope.

2. The automatic flight protection system as claimed in claim 1, wherein, when it takes control of the aircraft, the prohibited zone anti-penetration rig makes it follow an avoidance trajectory for avoiding the prohibited penetration zone.

3. The automatic flight protection system as claimed in claim 1, wherein, when it has taken control of the aircraft, the prohibited zone anti-penetration (cons. anti-collision) rig renders same to the crew of the aircraft as soon as it no longer detects intrusion of a prohibited zone of penetration into the flight safety protection envelope.

4. The automatic flight protection system as claimed in claim 1, wherein it comprises a prohibited zone anti-penetration rig constructing, in addition to the flight safety protection envelope, a penetration alert protection envelope, that is more extensive than the flight safety protection envelope, and a generator of alerts destined for the crew of the aircraft activated in case of intrusion of a prohibited zone of penetration into this penetration alert protection envelope.

5. The automatic flight protection system as claimed in claim 1, wherein it comprises a database listing the prohibited penetration zones and storing a representation of the relief or of an envelope of the relief.

6. The automatic flight protection system as claimed in claim 5, wherein it comprises a terrain anti-collision rig likening the risks of collision with the ground or obstacles on the ground to the detection of intrusions of the ground or of obstacles on the ground modeled with the help of the representation of the relief or of an envelope of the relief stored in the database, inside at least one ground protection envelope constructed around a position deduced from the current position of the aircraft as provided by the positioning system and alerting the crew of a risk of ground collision in case of detection of an intrusion of the ground or of an obstacle on the ground into the ground protection envelope.

7. The automatic flight protection system as claimed in claim 5, wherein it comprises a terrain anti-collision rig likening the risks of collision with the ground or obstacles on the ground to the detection of intrusions of the ground of obstacles on the ground modeled with the help of the representation of the relief or of an envelope of the relief stored in the database, inside at least one ground protection envelope constructed around a position deduced from the current position of the aircraft as provided by the positioning system, alerting the crew of a risk of ground collision in case of detection of an intrusion of the ground or of an obstacle on the ground into the ground protection envelope and offering it an avoidance trajectory.

8. The automatic flight protection system as claimed in claim 7, wherein its terrain anti-collision rig constructs, in addition to the ground protection envelope, a ground collision prealert protection envelope, that is more extensive than the ground protection envelope and alerts the crew of the need for a modification of the flight plan in case of intrusion of the ground or of an obstacle on the ground into this ground collision prealert envelope.

9. The automatic flight protection system as claimed in claim 5, wherein it comprises a prohibited zone anti-penetration rig and a terrain anti-collision rig having common protection envelopes.

10. The automatic flight protection system as claimed in claim 9, wherein the prohibited zone anti-penetration rig and the terrain anti-collision rig have identical flight safety protection and ground protection envelopes.

11. The automatic flight protection system as claimed in claim 9, wherein the prohibited zone anti-penetration rig and the terrain anti-collision rig have identical flight safety protection and ground protection envelopes and identical penetration alert protection and ground collision prealert envelopes.

12. The automatic flight protection system as claimed in claim 5, wherein it comprises a prohibited zone anti-penetration rig constructing, in addition to the flight safety protection envelope, a penetration alert protection envelope, a terrain anti-collision rig constructing a ground protection envelope and a ground collision prealert envelope, and a generator of alerts destined for the crew of the aircraft generating several sorts of alarms including:
a prohibited zone penetration risk prealarm in case of intrusion of a prohibited zone of penetration into the penetration alert protection envelope,
a ground collision risk prealarm in case of intrusion of the relief into the ground collision prealert protection envelope, and
a ground collision risk alarm in case of intrusion of the relief into the ground protection envelope.

13. The automatic flight protection system as claimed in claim 1, wherein it furthermore comprises a rig for alerting the air traffic control through which it advises the air traffic control of any taking of automatic control of the aircraft.

14. The automatic flight protection system as claimed in claim 1, wherein it furthermore comprises a strengthened surveillance rig actuatable by the crew of the aircraft and/or personnel on the ground and causing an extension on the protection volumes of the prohibited zone anti-penetration rig.

15. The automatic flight protection system as claimed in claim 1, wherein it furthermore comprises a deactivation rig preventing control of the aircraft being taken in case of a major breakdown of the flight rigs of the aircraft or during a final landing maneuver.

16. The automatic flight protection system as claimed in claim 1, wherein the prohibited zone anti-penetration rig acts at the level of the flight controls of the aircraft.

17. The automatic flight protection system as claimed in claim 1, wherein the prohibited zone anti-penetration rig implements protection volumes whose extents are dependent on the speed of the aircraft.
